(19) United States
(12) Patent Application Publication
(10) Pub. No.: US 2011/0056927 A1
(43) Pub. Date: Mar. 10, 2011

(54) Binding process for an air heater and structure thereof

(76) Inventor: Chia-Hsiung Wu, Taipei (TW)

(21) Appl. No.: 11/882,078

(22) Filed: Jul. 30, 2007

(51) Int. Cl. H05B 3/02; B32B 37/00

(52) U.S. Cl. 219/540; 156/64

(57) ABSTRACT

A binding process for an air heater and structure thereof, in particular a heater having application in air, in which various modularized prefabricated units are used to assemble and enable subsequent binding and rapid production of the heater. An electric conduction test is simultaneously implemented during the binding process, which enables accelerating the speed of solidification of a binding material and avoids a baking energy load. The present invention is able to withstand a relatively large assembly clamping pressure during the binding process, and achieves a substantially large secure mechanical force fit between the components after completing assembly that provides good conducting physical properties.

### BACKGROUND OF THE INVENTION

(a) Field of the Invention

The present invention relates to a binding process for an air heater and structure thereof, and more particularly to a heater having application in air, in which various units are fabricated in advance to enable subsequent binding and combining together in a modularized fashion, thereby providing quick assembly and saving manufacturing energy.

(b) Description of the Prior Art

In general, the majority of air heaters driven by fans have a plate-like exterior, and are structured by joining together heating units and heat dissipating units. The joining methods used include pressure clamping of structural members or binding methods. Referring to FIG. 1, which show assembly elements of a prior art heater 10, primarily comprising plate electrodes 11 joined to two sides of a heating element 1, wherein electric power is conducted through the plate electrodes 11 and flows into the heating element 1. Heat quantity produced by the heating element 1 is then indirectly dissipated through heat dissipating fins 12 via the plate electrodes 11. Heat exchange is carried out with air flowing past the heat dissipating fins 12, thereby achieving the objective of heating the air.

Referring to FIG. 2, the binding assembly method of prior art involves placing a cover 14 on a work platform 16, and a baking device 15 is fitted interior of the cover 14, thereby forming a baking environment space 140. Structural elements, including the heating elements 1, the plate electrodes 11 and the heat dissipating fins 12 are correspondingly arranged in an orderly disposition on the work platform 16 in the environment space 140 in accordance with requirements for the number of elements and corresponding relationship. The binding process involves applying a binding material to each adjoining contact surface, after which, two side jigs 13 exert a clamping pressure force P. While exerting the clamping pressure, the baking device 15 emits heat radiation waves R which dry the binding material. The drying method involves the heat radiation waves R gradually channeling through the outer surface to the core of each of the elements, and has the following shortcomings:

1. Because the heat waves in the baking process channel through the outer surface to the core of the elements, thus, transfer time is long, and state of solidification varies.

2. The structure assembles a loose arrangement of the various elements, and if there is force displacement of the clamping pressure P, then assembly precision is lost.

3. When the elements are loose and the clamping pressure is excessive, then the elements become deformed.

4. After binding is completed, if it is discovered that the heating element has flaws, but the binding material has already solidified, thus making replacement of the heating element impossible, then the entire structure must be discarded, thereby resulting in wastage of materials and equipment.

5. During the solidification and binding process, the baking device must be used to emit heat waves, thereby, causing energy wastage during the assembly process.

6. Because of the large baking space, thus, the jigs must be provided with rigidity, and in general are made from metal material that has a large enthalpy quantity which adsorbs heat waves, thereby increasing energy load of the baking device.

7. Because the jigs are provided with an enthalpy effect that adsorbs heat waves, thus, the hands of a worker are easily scalded during operation.

8. Although the cover can be provided with a heat resistant function, it is impossible for it to be completely heat resistant, thus, heat waves will be lost through outward transmission, resulting in heat quantity inside the baking space being dispersed along with Brownian movement of the air to the production line working environment, thereby causing heat pollution, especially in the summer.

9. Because the heat dissipating fins and the plate electrodes are made from metal material, thus, they are affected by thermal expansion and contraction, accordingly, during the joining process, they adsorb heat and expand, and contract when cool. Hence, when the heating period is long, the amount of deformation is large, and contraction after cooling causes a correspondingly increase in displacement, resulting in the molecules of the binding material easily tearing, thus degree of bonding firmness and durability between the contact surfaces is lost.

### SUMMARY OF THE INVENTION

A primary objective of the present invention is to provide a binding process for an air heater and structure thereof, which primarily comprises main units making up a heater, wherein each of the units are separately fabricated in advance. The units include heat exchanger units and a heating unit, and a substantially high binding force is achieved after assembling the units. Moreover, the present invention enables rapid assembly production, and an electric conduction test is carried out at the same time as a binding process. Heat quantity produced by the electric conduction test is used as catalytic energy for a solidification reaction of a binding material, thereby avoiding energy wastage of conventional baking methods, and enabling rapid binding and production.

A second objective of the present invention is to provide a secure fixing insulating jacket located at a conducting electrode end of each of the heat exchanger units, which insulates heat dissipating fins from electrical property, and provides buffering of the mechanical force produced when inserting/pulling out the heat exchanger units, as well as functioning to provide salt and physical tolerance.

A third objective of the present invention, is to cover the exterior of the entire heater, after assembling the various units, with an insulating protective membrane that functions to provide physical tolerance or chemical resistance, or to facilitate creating an electrical blockage with other surrounding structural members. The usage environment, such as application in a car body, enables creating an electrical blockage with other neighboring components within the car body.

A fourth objective of the present invention is to use the heating unit as a heat source during the binding process and simultaneous implementation of the electric conduction test, whereby heat from the electric conduction test is directly transmitted to the binding interfaces by planar transmission, thereby enabling producing a uniform binding state at each binding unit area.

A fifth objective of the present invention lies in the binding process of the various component members, wherein during implementation of the electric conduction test, if there are flawed electrical component members, then there is enough time to be able to dismantle and take out the good components before solidification of the binding material has occurred, thereby avoiding wastage of materials, equipment and man-hours.

A sixth objective of the present invention is to interpose the heat exchanger units with heat conducting insulating plates to insulate the heat dissipating fins from electrical property, wherein the insulating plate is made from mineral material, such as aluminum oxide, provided with high mechanical strength.

A seventh objective of the present invention is to enable the heater to be assembled from a variable number of units, thereby enabling a different number of the units to be chosen to quickly accommodate different power production systems, and swiftly accommodate market demand, thus eliminating the need to consider a safety stock of production line components.

An eighth objective of the present invention is to use jigs to provide clamping pressure during the manufacturing process, wherein the jigs need not be made from high temperature resistant material, thereby reducing cost of the jigs, or the jigs can be made from thermal resistant material to prevent loss of heat.

A ninth objective of the present invention is to substantially reduce production line assembly working space during implementation of the present invention.

A tenth objective of the present invention is to completely eliminate energy use of baking methods during the assembly production process, without the threat of scalding the hands of workers, and provide an operating space that is of open type that facilitates handling.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows an elevational view depicting relationship between structural members of a prior art heater.

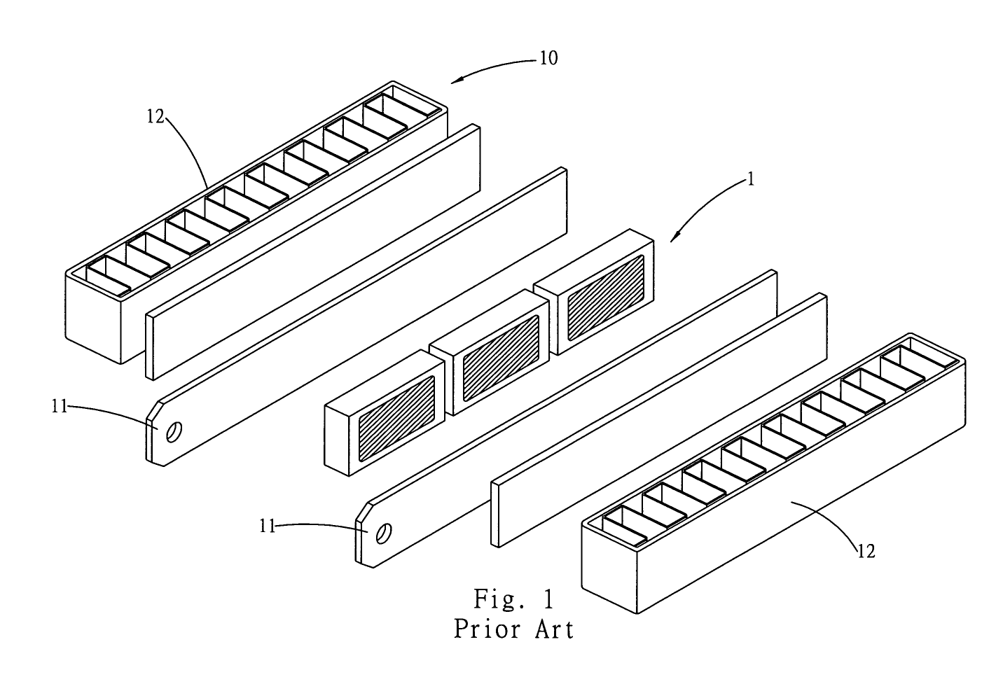

FIG. 2 shows a schematic view depicting installation of an assembled heater of prior art.

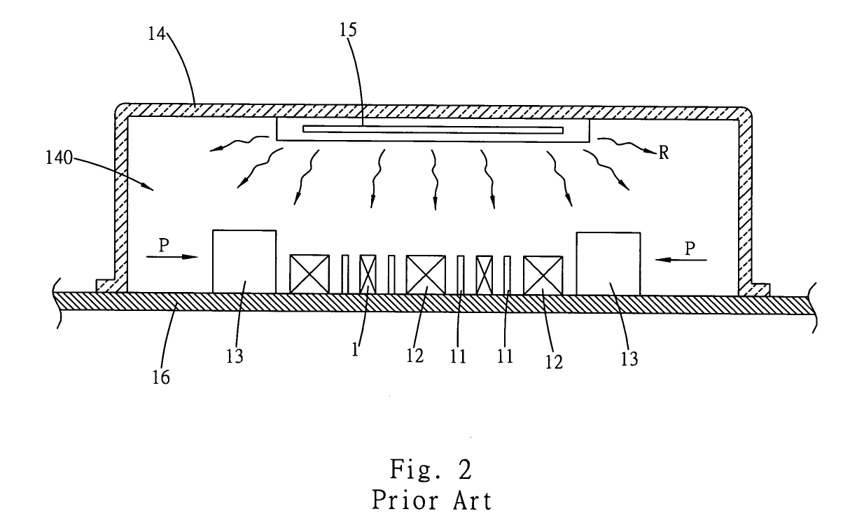

FIG. 3 shows an elevational view depicting independent relative relationship of units according to the present invention.

FIG. 4 shows an elevational view depicting external appearance of the present invention assembled.

FIG. 5 shows an elevational schematic view depicting an embodiment of a heating unit according to the present invention.

FIG. 6 shows an external appearance of a pre-completed heat exchanger unit of the present invention.

FIG. 7 shows an elevational view depicting structural relationship of an insulating jacket of a further embodiment of the present invention.

FIG. 8 shows an elevational view depicting structural relationship of the heat exchanger units complete with the insulating jackets according to the embodiment of the present invention.

### DETAILED DESCRIPTION OF THE PREFERRED EMBODIMENTS

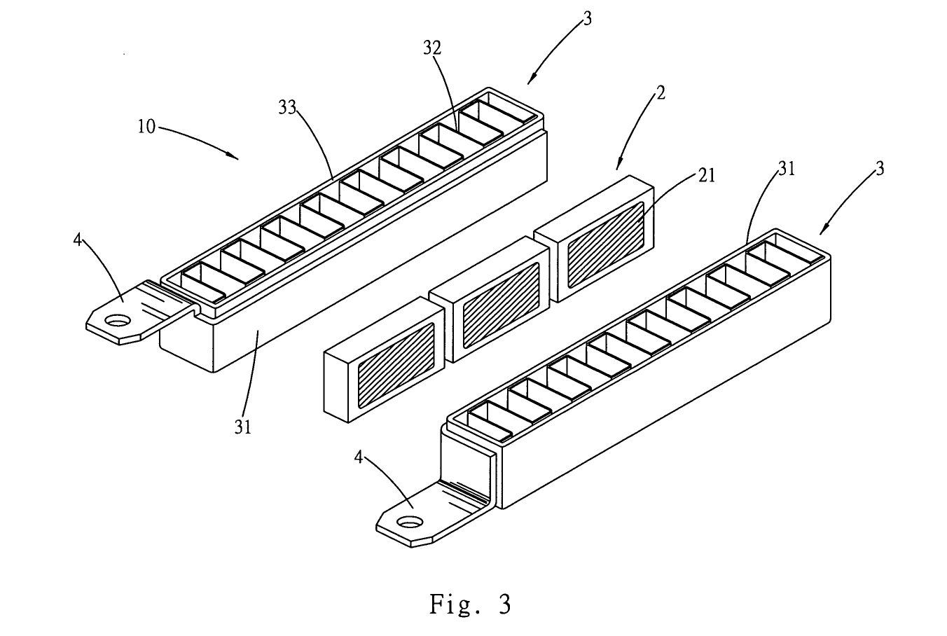

Referring to FIG. 3, which shows an embodiment of the present invention, primarily structured to comprise a heating unit 2 and reciprocal heat exchanger units 3, which are units fabricated in advance and constitute a heater 10, wherein the heat exchanger units 3 are respectively assembled from plate electrodes 31 and terminals 4 that respectively extend from an end thereof. Each of the heat exchanger units 3 comprises fins 32 that serve to exchange heat with the air, and a periphery is disguised with a shaped frame 33. The heating unit 2 comprises any plate-type heating elements 21, and the heating elements 21 can be positive temperature coefficient ceramic resistor heating strips, a series assembly of a plurality of which forms the plate-type heating unit 2.

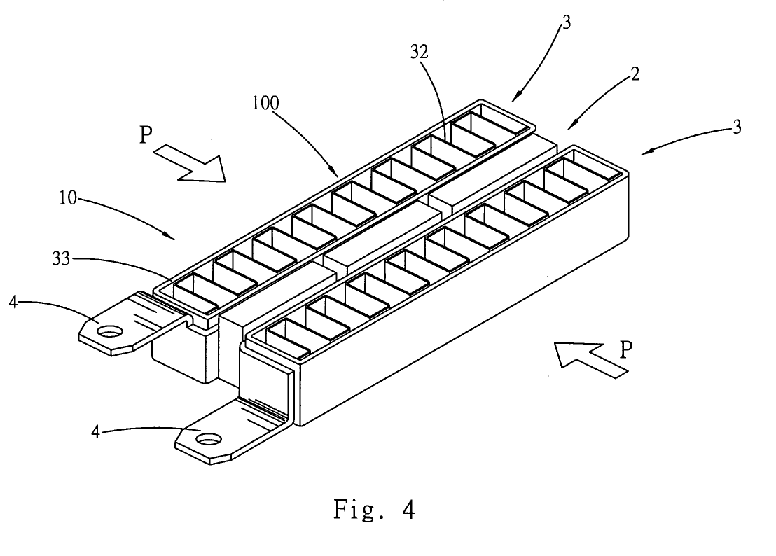

Referring to FIG. 4, which shows the heater 10 of the present invention assembled by bonding together the independent prefabricated heating unit 2 and heat exchanger units 3, wherein binding material is applied in advance to corresponding joining surfaces of the heat exchanger units 3 and heating unit 2, after which clamping pressure P from jigs (not shown in the drawings) on two outer sides presses and fixes the structure of the heater 10. Because the heat exchanger units 3 and the heating unit 2 are prefabricated in advance, thus, pre-positioned combined mechanical force has already been achieved between the various components, hence, the units are able to withstand the substantially high pressure from the clamping pressure P, thereby enabling contact surfaces between the heat exchanger units 3 and the heating unit 2 to withstand a substantially high clamping pressure, and a substantially densely pressed binding filling of the binding material (not shown in the drawings) is able to be press filled between the heat exchanger units 3 and the heating unit 2.

During the pressing process, electric power is conducted from the terminals 4 for an electric conduction test to detect whether electric heating is working normally or not. Moreover, test parameters can be simultaneously extracted, and if it is discovered that the heating unit 2 has flaws, because the binding material has not yet solidified, thus, the heat exchanger units 3 can be quickly dismantled and the heating unit 2, and the heating unit 2 replaced, or, during the process of applying the clamping pressure P, the heat exchanger units 3 lose mechanical resistance and collapse, then the heat exchanger units 3 can be replaced. The aforementioned prompt replacements can be implemented before the binding material has solidified, and thus facilitates full retrieval and use of resources.

During the electric conduction test, the heating unit 2 produces heat waves, which directly effect thermo catalysis of the binding material of the adjoining surfaces between the heat exchanger units 3 and the heating unit 2, thereby causing the binding material to quickly solidify. Accordingly, simultaneous implementation of the electric conduction test in the present invention not only enables prompt detection of whether components are working normally or not, but also enables using the heat quantity produced during the detection process to directly accelerate solidification of the binding material. Moreover, heat is uniformly produced at the contact surfaces between the heat exchanger units 3 and the heating unit 2, thereby enabling an equal solidification state of the binding material to be formed on the surface areas between the heat exchanger units 3 and heating unit 2. Furthermore, the jigs do not need to be subjected to a heat effect, and only apply mechanical pressure, thus, the jigs need not be made from high temperature resistant material, though using material having heat resistant properties enables preventing the heating unit 2 from absorbing heat waves and being damaged during the electric conduction test.

The combinatory procedure of the embodiment of the present invention can be implemented on the working production line of any platform, and does not need a special baking environment. The combinatory procedure does not obstruct space, and after assembling the heat exchanger units 3 and the heating unit 2 to form a heating entity 100, then the present invention can combine a plurality of the heat exchanger units 3 and the corresponding number of heating units 2 using a juxtaposed arrangement or any stacking arrangement according to requirements for the number of units of the single heating entity 100, thereby increasing the quantity of heating units 2 and enabling modifying hot working power of the heater 10. The present invention thus enables fast production to quickly accommodate different power requirements.

During the electric conduction test, the entire heating unit 2 simultaneously generates heat, thus, the bonding contact surfaces simultaneously receive a heat effect, thereby eliminating time for thermal equilibrium, and the resulting quick binding solidification improves production rate.

Each of the heat exchanger units 3 is made up from the heat dissipating fins 32 that serve as the functional main bodies, and outer periphery of the heat dissipating fins 32 is fixedly secured with the shaped frame 33. Any soldering method or binding process can be used as the joining method between the heat dissipating fins 32 and the shaped frame 33. The binding process can use normal temperature solidified binding material, with the condition that it is provides heat conduction after completing the binding process.

During the electric conduction test, the quantity of heat produced is able to accelerate solidifying rate of the binding material. If the binding material demands a large quantity of heat to catalyze, then time for testing electric conduction can be extended, and accordingly produce a relatively larger quantity of heat to satisfy acceleration requirements for solidifying the binding material.

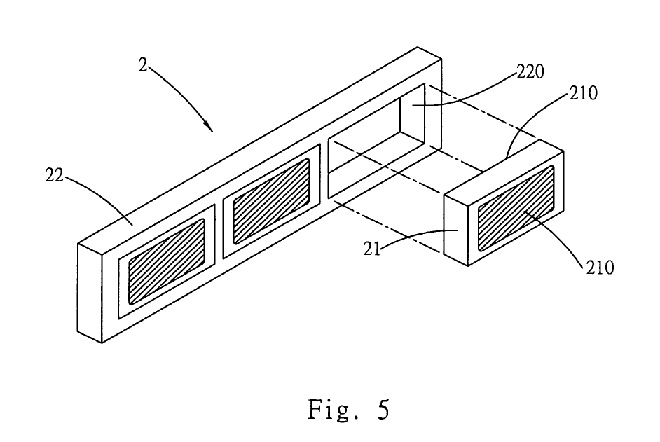

Referring to FIG. 5, which shows the heating unit 2 comprising the plate heating elements 21, wherein front and rear surfaces of each of the heating elements 21 is provided with an electrical conducting surface 210, thereby enabling electric current to pass therethrough. Each of the heating elements 21 is an electric heating element of any material, and is basically a solid body of substantially high mechanical strength, such as a positive temperature coefficient (PTC) ceramic resistance strip, outer periphery of which is framed with a frame 22. The frame 22 is made from material having durable physical properties, interior of which is configured with embedding cavities 220 that enable the heating elements 21 to respectively embed therein. The heating elements 21 can adopt a dry assembly method to embed into the embedding cavities 220, or binding material can be applied to the embedding interfaces, thereby fixedly bonding the heating elements 21 in the frame body 22. Implementation of the frame body 22 enables defining and assembling the single flat type heating unit 2 from a plurality of the heating elements 21.

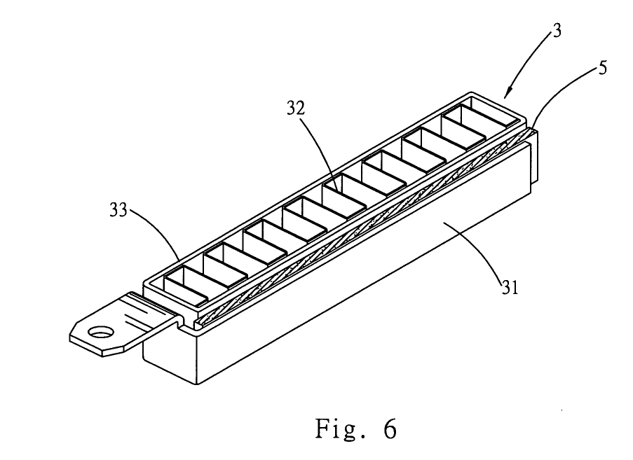

Referring to FIG. 6, which shows the heat exchanger unit 3, wherein a heat conduction insulating plate 5 is disposed between and separates the plate electrode 31 and the heat dissipating fins 32. The heat conduction insulating plate 5 separating the plate electrode 31 from the heat dissipating fins 32 enables insulating the heat dissipating fins 32 from electrical property. The shaped frame 33 fitted on the outer periphery of the heat dissipating fins 32 fixedly secures structure thereof, and a solidification binding process can be similarly adopted between the shaped frame 33, the insulating plate 5 and the plate electrode 31, using normal temperature or any method to achieve the binding, which in principle must be completed in advance to enable the insulating plate 5 to be strongly interposed between the plate electrode 31 and the heat dissipating fins 32 or the shaped frame 33 enclosing thereof, thereby forming the single heat exchanger unit 3.

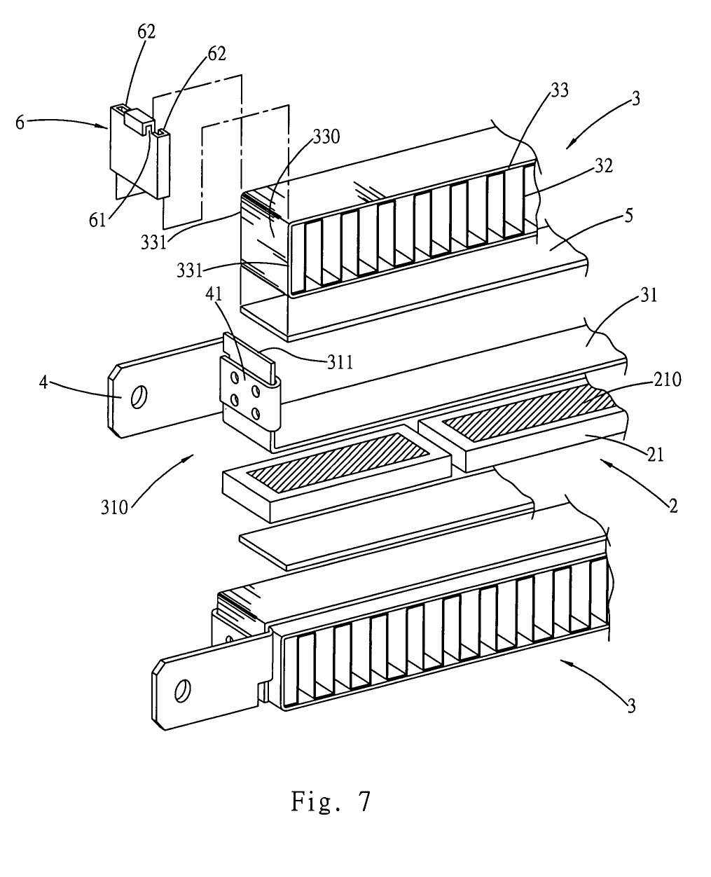

Referring to FIG. 7, which shows the heat exchanger units 3 respectively structured to comprise the heat dissipating fins 32 and the shaped frame 33 joined to the plate electrode 31 by means of the heat conduction insulating plate 5. The terminals 4 respectively extend from one side of the plate electrodes 31, and the insulating plates 5 effectively insulate the plate electrodes 31 from the heat dissipating fins 32, thereby enabling forming electrical insulation. The terminals 4 are exposed, and basically must be fixed attachments disposed in a separate arrangement according to position of an electric plug. One end of each of the plate electrodes 31 is provided with a bent portion 310 formed from a bent surface 311. The present invention further comprises the independent terminals 4 each indirectly joined to the bent surface 311. A folded plate 41 is located at an inner portion of each of the terminals 4 corresponding to the bent portion 310, and the folded plate 41 embraces the bent surface 311, with any rivet connection or stamping method being used to achieve mechanical joining thereof. After joining, insulating material is packed between the bent portion 310 and a corresponding end surface 330 of the shaped frame 33, thereby realizing electrical insulation between the bent portion 310 and the end surface 330.

The present invention further uses insulating jackets 6 to serve as electrical insulation for the end surfaces 330; and mechanical clamping force of the insulating jackets 6 extending over the bent portions 310 is used to fixedly clamp the bent portions 310, thereby mechanically fixing the terminals 4. The insulating jacket 6 comprises two hook plates 62 that clamp on a side 331 of each of the end surfaces 330. A clamp groove 61 extends from one side of each of the insulating jackets 6, and the clamp grooves 61 respectively clamp on corresponding edges of the bent portions 310. Accordingly, such a clamping configuration assembles corresponding surfaces of the plate electrodes 31 and the insulating plates 5 with the shaped frame 33, and outwardly facing surfaces of the plate electrodes 31 are respectively electrically connected to the electrical conducting surfaces 210 of the heating elements 21 of the heating unit 2 to establish electrical conduction therewith.

Implementation of the aforementioned insulating jackets 6 enables gaps formed by the insulating jackets 6 to separate electrical property at one end of the terminals 4, and thickness of the insulating jackets 6 enables extending creepage distance between the terminals 4 and the heat dissipating fins 32, and elimination thereof. Moreover, existence of the insulating jackets 6 increases ability to tolerate salt, that is, during system application, provides good chemical resistance or physical tolerance.

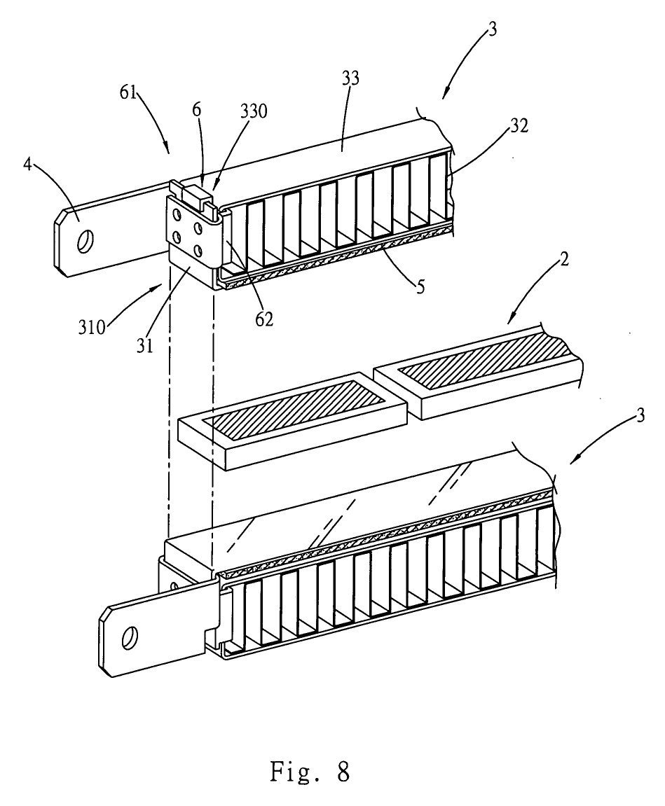

Referring to FIG. 8, which show one of the insulating jackets 6 clamped to the end surface 330 of the shaped frame 33 and the clamp groove 61 clamped on the side edge of the bent portion 310, accordingly, clamping of the terminal 4 by the clamp groove 61 fixes one side of the terminal 4. Another side of the plate electrode 31 extends from the bent portion 310 to an underside of the insulating plate 5, and is fixed at two points. In addition, the insulating jacket 6 is a long body that forms another axial fixing, thereby providing a three dimensional fixing installation for the terminal 4. Moreover, the gaps of the insulating jackets 6 provide electrical insulation for the heat dissipating fins 32 or the shaped frames 33, and further provide a mechanical buffering force when inserting or pulling out the terminals 4 from a power source. A high mechanical binding force is provided with between each of the component members, including the plate electrode 31, the insulating plate 5, the insulating jacket 6 and the terminal 4 that comprise the completed heat exchanger unit 3. Moreover, each of these component members can be manufactured using standardized production, thereby quickly fabricating the heat exchanger units 3 or the heating units 2, and after manufacturing the units, the assembly method depicted in FIG. 4 is used to quickly produce the heater 10.

A protective membrane can be attached to the exterior surfaces of related metal surfaces of the aforementioned completed heater 10, thereby providing electrical insulation, and even achieving resistance from chemical corrosion.

According to the aforementioned embodiments, the present invention is able to be easily assembled to a general production line platform. Moreover, the present invention is able to avoid burdening other heat energy sources during the binding process, and dispenses with the use of covering equipment, without the threat of scalding the limbs and trunk of a worker during the operating process. Furthermore, the present invention does not cause thermal pollution, and operating space is of open type that does not hinder assembly, the limbs and operation thereof. The binding solidification process and simultaneous implementation of the electric conduction test not only enables valid parameters to be obtained, moreover, heat waves produced during the electric conduction test can also be used to directly serve as a catalyst for the solidification process, thereby reducing the binding solidification time and increasing high performance productivity. The solidification binding state enables uniform bonding of each unit area of the joining surfaces, thereby enabling the bonding strength to have uniform degree of rigidity. Moreover, the independently completed units assembled in advance are single entities, which are able to resist substantially high pressure from jigs during the course of assembling the heating units 2 , and enables closely knit joining of the electric and heat conducting interfaces. Moreover, each of the units can be independently mass pre- produced using standardized production, thereby eliminating the need to consider an inventory of components. Accordingly, the present invention is provided with multiple advantages in production implementation.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A binding process for a heater, wherein modularized independent production and fabrication of main units enable a binding process to provide subsequent rapid joining to form a heater, comprising:
step one: prefabricating at least one plate-type heating unit and at least two heat exchanger units, wherein a plate electrode is joined to each of the heat exchanger units;
step two: applying binding material to corresponding adjoining surfaces of each of the units;
step three: clamping the heat exchanger units to the heating units according to electrical arrangement, horizontally disposing on a work platform in an open space, and assembling together a prototype of a heating entity;
step four: applying pressure to the exterior of two sides of the heating entity using jigs;
step five: simultaneously implementing an electric conduction test during applying pressure, and extracting electrical parameters;
step six: using heat from the electric conduction test to effect solidifying a binding material;
step seven: extracting end product after completing solidification.

2. The binding process for a heater according to claim 1, wherein according to the number of units required to form the heating entity of step 3, more than two of the heating units and the corresponding number of the heat exchanger units are serially connected to expand the power and area of the heater.

3. The binding process for a heater according to claim 1, wherein the electric conduction test of step 5 is able to raise heat energy according to different requirements for the thermal strain state of the binding material, thereby achieving greater thermal catalytic solidification of the binding material.

4. A joining structure for a heater, comprising:
at least one heating unit, which has at least one plate-type positive temperature coefficient ceramic resistor heating element as the heat source;
at least one pair of heat exchanger units, one side of each of which is provided with a plate electrode fabricated in advance, and a terminal is exposed from one end of each of the plate electrodes;
the plate electrodes of the two heat exchanger units are aligned with electrode conducting surfaces of the heating unit and joined to form a heating entity using a binding process.

5. The joining structure for a heater according to claim 4, wherein a plurality of sets of the heating entity are serially connected to expand the power and area of the heater.

6. The joining structure for a heater according to claim 4, wherein each of the heat exchanger units comprises the plate electrode and heat dissipating fins, between which the mineral heat conducting insulating plate insulates electrical property, thereby preventing the fins from having electrical property.

7. The joining structure for a heater according to claim 6, wherein the heat exchanger units are electronegative electrodes, thereby avoiding disposition of the insulating plates.

8. The joining structure for a heater according to claim 6, wherein the insulating plates are made from aluminum oxide mineral material provided with high mechanical strength.

9. The joining structure for a heater according to claim 4, wherein the heat exchanger units are configured with the heat dissipating fins, and shaped frames respectively enclose outer peripheries of the heat dissipating fins.

10. A joining structure for a heater, comprising:
at least one heating unit, wherein a heat exchanger unit provided with a plate electrode is respectively joined to two sides of the heating unit, thereby forming a basic heating entity, wherein the heat exchanger unit comprises the plate electrode joined to heat dissipating fins and a heat conduction insulating plate interposed therebetween, thereby insulating electrical property from the heat dissipating fins; one end of the plate electrodes is provided with a bent portion that is connected to a terminal, the bent portion is bonded to an insulating jacket joined to a corresponding end surface of the heat dissipating fins, thereby fixing position of the terminal.

11. The joining structure for a heater according to claim 10, wherein the terminals are independent members, which are joined to a bent surface formed after stamping out the plate electrode.

12. The joining structure for a heater according to claim 10, wherein the pre-completed plate electrode, insulating plate and heat dissipating fins are fixed together using a binding process.

13. The joining structure for a heater according to claim 10, wherein a shaped frame encloses the outer periphery of the heat dissipating fins, and an end of the shaped frame corresponding to the terminal enables the insulating jacket to be joined thereto.

14. The joining structure for a heater according to claim 10, wherein a plurality of sets of the heating entity are assembled abreast and connected in series, thereby expanding heat dissipating power and heat dissipating area.

15. The joining structure for a heater according to claim 10, wherein the heating entity uses positive temperature coefficient ceramic resistors as heating elements.

16. The joining structure for a heater according to claim 15, wherein an outer periphery of the heating elements is fixedly secured with a frame.

17. The joining structure for a heater according to claim 1, wherein exterior surfaces of related metal surfaces of the completed heater are covered with a protective membrane having insulating properties.

18. The joining structure for a heater according to claim 4, wherein exterior surfaces of related metal surfaces of the completed heater are covered with a protective membrane having insulating properties.

19. The joining structure for a heater according to claim 10, wherein exterior surfaces of related metal surfaces of the completed heater are covered with a protective membrane having insulating properties.
